(19) United States
(12) Patent Application Publication
(10) Pub. No.: US 2010/0158543 A1
(43) Pub. Date: Jun. 24, 2010

(54) IMAGE FORMING APPARATUS, HOST APPARATUS AND STAPLING CONTROL METHOD THEREOF

(75) Inventor: Seok-heon CHAE, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/623,578

(22) Filed: Nov. 23, 2009

(30) Foreign Application Priority Data
Dec. 24, 2008 (KR) 2008-133320

(51) Int. Cl. G03G 15/00; B42C 1/12; G06F 3/12

(52) U.S. Cl. 399/8; 270/58.08; 399/410; 358/1.15

(57) ABSTRACT

An image forming apparatus, a host apparatus and a stapling control method thereof, the method including displaying a plurality of selectable jobs; selecting a plurality of the selectable jobs to be stapled together; and stapling the selected jobs together while maintaining printing properties of each of the respective selected jobs.

### CROSS-REFERENCE TO RELATED APPLICATIONS

This application claims the benefit under 35 U.S.C. §119(a) of Korean Patent Application No. 10-2008-0133320, filed on Dec. 24, 2008, in the Korean Intellectual Property Office, the disclosure of which is incorporated herein by reference in its entirety.

### BACKGROUND

1. Field of the Invention

Apparatuses and methods consistent with the present general inventive concept relate to an image forming apparatus, a host apparatus and a stapling control method thereof, and more particularly to an image forming apparatus, a host apparatus and a stapling control method thereof in which recording media corresponding to a plurality of jobs can be affixed together.

2. Description of the Related Art

An image forming apparatus forms an image to be printed on a recording medium. The image forming apparatus may include a printer, a copying machine, a facsimile, a multi-function peripheral having two or more functions, etc.

Recently, a demand for an office automation system in which the image forming apparatus performs the functions of a scanner, a facsimile, etc., as well as a function of printing a document, in other words, performing functions like a multi-function peripheral device, has been on the rise. Accordingly, the image forming apparatus has been gradually developed to have higher performance, thereby extending its effective functions.

For example, the image forming apparatus may be provided with an electric stapler to perform a function of stapling printed or copied output materials.

To use the function of stapling such output material, a user selects a printing or copying menu according to jobs and then selects a stapling option in the selected menu. Then, the image forming apparatus forms images on recording media supplied from a feeding tray and carries out the stapling function after a process of forming an image on the last recording medium is completed, thereby discharging the stapled recording media.

In some cases, a user may want to staple a plurality of associated jobs together.

However, the stapling function provided in the conventional image forming apparatus can typically only be set up according to respective jobs. Therefore, in a case in which the plurality of jobs are needed to be stapled together, the image forming apparatus prints the plurality of jobs and then a user has to manually staple the completed print media. Thus, the conventional image forming apparatus is inconvenient for a user.

Further, the conventional image forming apparatus does not provide a user any option on stapling since it can perform the stapling only by a unit of a job.

According to another conventional image forming apparatus, the plurality of jobs can be combined and printed as a single job to be stapled together.

However, the conventional image forming apparatus mentioned above, which combines the plurality of jobs to be printed and stabled together like a single job, performs not only the stapling but also the printing as a single job, so that respective printing properties cannot be maintained with regard to each of the plurality of jobs.

### SUMMARY

Example embodiments of the present general inventive concept provide an image forming apparatus, a host apparatus and a stapling control method thereof, in which a plurality of jobs are stapled together while maintaining printing properties of each respective job, thereby providing a more efficient and economical stapling operation and providing a user various options.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a stapling control method of an image forming apparatus that performs printing with respect to a plurality of jobs, the method including displaying a plurality of selectable jobs; selecting a plurality of the selectable jobs to be stapled together; and stapling the selected jobs together while maintaining printing properties of each of the respective jobs.

The method may further include setting the printing properties with respect to the selected jobs.

The setting of the printing properties may include setting the printing properties of the selected jobs to be equal.

The method may further include discharging recording media that are stapled together.

The displaying of the plurality of selectable jobs may include displaying a list of plural selectable jobs stored in the image forming apparatus.

The selecting of the plurality of selectable jobs may include selecting a plurality of files corresponding to the plurality of selectable jobs through a graphical user interface (GUI) in a host apparatus connectable with the image forming apparatus.

The method may further include displaying that the selected jobs are set to be stapled together.

The foregoing and/or other features and utilities of the present general inventive concept may also be achieved by providing an image forming apparatus including an image forming unit to print a plurality of jobs; a display unit to display a plurality of selectable jobs; a user selection unit to allow a user to select a plurality of the selectable jobs to be stapled together; a stapling unit to staple recording media on which the printing is completed; and a controller to control the stapling unit to staple the recording media corresponding to the selected jobs together while maintaining printing properties of each of the respective selected jobs.

The user selection unit may allow the user to set printing properties with respect to the selected jobs.

The user selection unit may allow the user to set the printing properties of the selected jobs to be equal.

The image forming apparatus may further include a medium discharging unit to discharge recording media that are stapled together.

The image forming apparatus may further include a storage unit in which a plurality of jobs are stored, wherein the display unit displays a list of plural selectable jobs stored in the storage unit.

The display unit may display that the selected jobs are set to be stapled together.

The foregoing and/or other features and utilities of the present general inventive concept may also be achieved by providing a host apparatus connectable with an image forming apparatus, the host apparatus including a communication unit to communicate with the image forming apparatus; a display unit to display a plurality of selectable jobs; a user selection unit to allow a user to select a plurality of the selectable jobs to be stapled together; and a controller to control the communication unit to transmit a command to staple the selected jobs together while maintaining printing properties of each of the respective selected jobs.

The user selection unit may allow the user to set printing properties with respect to the selected jobs.

The user selection unit may allow the user to set the printing properties of the selected jobs to be equal.

The user selection unit may allow the user to select a plurality of files corresponding to the plurality of selectable jobs through a GUI.

The display unit may display that the selected jobs are set to be stapled together.

The foregoing and/or other features and utilities of the present general inventive concept may also be achieved by providing a recording medium having recorded thereon a program to control a computer to perform a method of controlling stapling of a plurality of jobs, the method including displaying a plurality of selectable jobs; selecting a plurality of the selectable jobs to be stapled together; and stapling the selected jobs together while maintaining printing properties of each of the respective jobs.

The foregoing and/or other features and utilities of the present general inventive concept may also be achieved by providing a method of affixing a plurality of printed jobs together, the method including selecting a plurality of jobs to be affixed together; and affixing the selected jobs together upon printing of the selected jobs; wherein respective printing properties of the selected jobs are maintained during the printing.

The method may further include displaying a plurality of selectable jobs. The selectable jobs may be displayed at an image forming apparatus which performs the printing, or at a location away from the image forming apparatus which performs the printing.

The selecting of the plurality of jobs may be performed at the image forming apparatus which performs the printing, or at a location away from the image forming apparatus which performs the printing.

The printing properties may include paper size, paper orientation, layout, double/single-sided printing, reverse-ordered printing, or any combination thereof.

The foregoing and/or other features and utilities of the present general inventive concept may also be achieved by providing a method of printing a plurality of print jobs, the method including affixing the plurality of print jobs together upon printing of the print jobs; wherein respective printing properties of the print jobs are maintained during the printing.

The foregoing and/or other features and utilities of the present general inventive concept may also be achieved by providing an image forming apparatus including an affixing device to affix sheets of recording media together; and a control circuit to control the affixing device to affix a plurality of print jobs together upon printing of the print jobs; wherein respective printing properties of the print jobs are maintained during the printing.

The image forming apparatus may further include a display to display a plurality of selectable jobs that may be printed.

The image forming apparatus may further include an input unit through which a user may select the print jobs to be affixed together.

The image forming apparatus may further include a communication unit to receive print data regarding the print jobs to be affixed together.

The print data may include a selection of the print jobs to be affixed together, affixing properties, the respective printing properties, or any combination thereof.

### BRIEF DESCRIPTION OF THE DRAWINGS

These and/or other features and advantages of the present general inventive concept will become apparent and more readily appreciated from the following description of the exemplary embodiments, taken in conjunction with the accompanying drawings, of which:

FIG. 1 is a block diagram illustrating an image forming apparatus according to an exemplary embodiment of the present general inventive concept;

FIG. 2 illustrates a selecting screen used to select a plurality of jobs according to the embodiment illustrated in FIG. 1;

FIG. 3 illustrates a setting screen used to set stapling options according to the embodiment illustrated in FIG. 1;

FIG. 4 is a block diagram illustrating a host apparatus according to another exemplary embodiment of the present general inventive concept;

FIG. 5 illustrates a selecting screen used to select a plurality of jobs according to the exemplary embodiment illustrated in FIG. 4;

FIG. 6 illustrates a setting screen used to set stapling options according to the exemplary embodiment illustrated in FIG. 4; and

FIG. 7 is a flowchart illustrating a stapling control method according to an exemplary embodiment of the present general inventive concept.

### DETAILED DESCRIPTION OF THE EMBODIMENTS

Reference will now be made in detail to various exemplary embodiments of the present general inventive concept, examples of which are illustrated in the accompanying drawings, wherein like reference numerals refer to like elements throughout. The embodiments are described below in order to explain the present general inventive concept by referring to the figures.

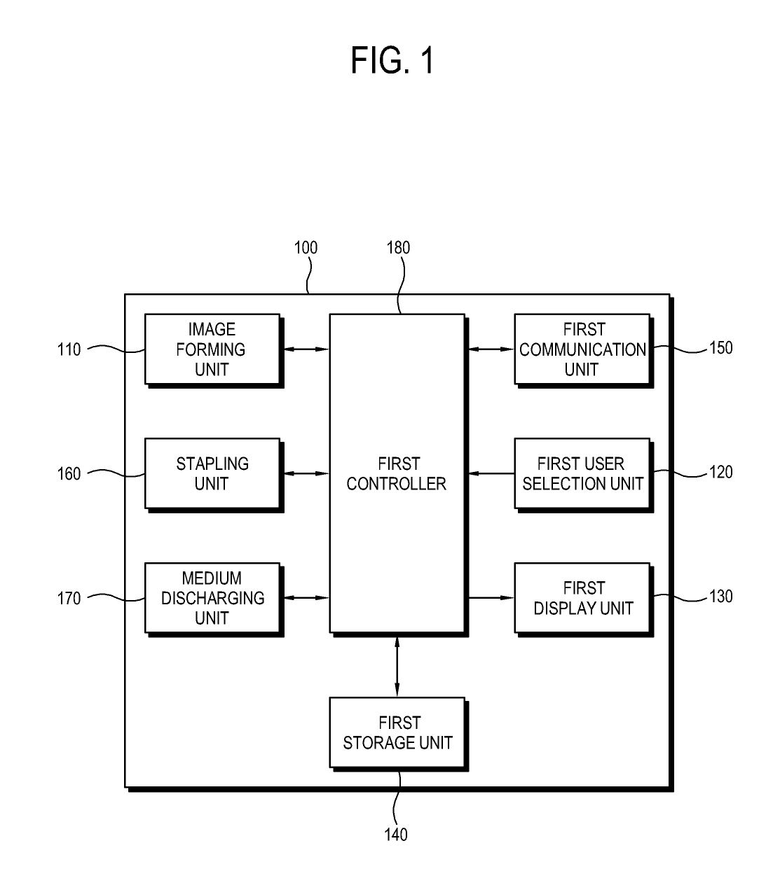

FIG. 1 is a block diagram illustrating an image forming apparatus 100 according to an exemplary embodiment of the present general inventive concept. The image forming apparatus 100 may include a printer, a copying machine, a facsimile, a multi-function peripheral having two or more functions, etc.

The image forming apparatus 100 according to this exemplary embodiment of the present general inventive concept may print out print data onto at least one sheet of a recording medium, such as paper.

The image forming apparatus 100 may also affix a plurality of sheets of the recording medium together to increase the convenience of a user of the image forming apparatus 100. The methods and/or devices of affixing the sheets together may take one or more of several forms. Although the embodiments described below generally refer to stapling as the manner of affixing the sheets together, the present general inventive concept is not limited thereto.

As shown in FIG. 1, the image forming apparatus 100 may include an image forming unit 110, a first user selection unit 120, a first display unit 130, a first storage unit 140, a first communication unit 150, a stapling unit 160, a medium discharging unit 170, and a first controller 180.

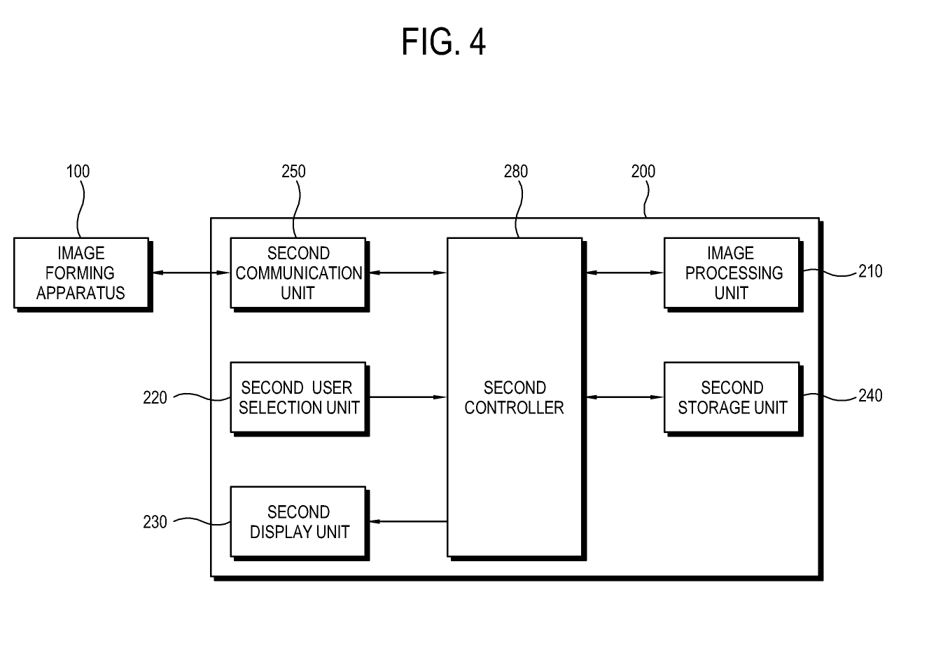

The image forming unit 110 may print an image based on print data to at least one medium (such as, for example, paper) in response to a print command. The print data may include print data of a copy after scanning a document, print data of received fax data, print data received from an external host apparatus 200 (discussed later in regards to FIG. 4) such as a server or stored in an interior (hard disk drive (HDD)) or exterior (universal serial bus (USB) memory) device of the image forming apparatus 100, etc.

The first user selection unit 120 may receive a user's command. The first user selection unit 120 may include a key button (hereinafter, referred to as “hard key” or a “key pad”) provided as part of the image forming apparatus 100, a graphic user interface (GUI) produced by execution of a printer driver or a separate application and displayed on the first display unit 130 to thereby allow a user to input a command through the GUI, etc.

Through the first user selection unit 120, a user may select plural jobs to be stapled together among a plurality of jobs, and may set stapling options with regard to the selected plural jobs. The stapling options may include options such as a stapling orientation, a stapling position, etc.

The first user selection unit 120 may allow a user to set printing properties with respect to each of the selected plural jobs. Also, if a plurality of stored jobs stored in the first storage unit 140 are to be stapled together, the process of setting the printing properties may be omitted with respect to the plurality of jobs.

A user may set the plural jobs to have different printing properties from one another. Thus, the image forming apparatus 100 in this embodiment can staple the plural jobs together while keeping the respective printing properties of each of the plural jobs.

Also, a user may perform a log-in, i.e., inputting an input identification (ID) code assigned to his/her account and password through the first user selection unit 120. The log-in may include an administrator mode log-in, after which an administrator is allowed to set and modify all environments without any separate limitation on access. If the log-in is performed as a general user or an administrator, the image forming apparatus 100 may implement authentication and permission with regard to the log-in.

According to an exemplary embodiment of the present general inventive concept, a user's command may be input through a remote user interface (RUI) or a web user interface (WUI) displayed in the host apparatus 200 (refer to FIG. 4), such as a personal computer (PC) or the like, remotely connectable to the image forming apparatus 100 through the first communication unit 150. An example in which a user's command is input through the RUI will be described in more detail in the discussion of the exemplary embodiment of FIG. 4.

The first display unit 130 may display a user setting and operating statuses of the image forming apparatus 100, and may display a GUI screen used to allow a user to input various commands.

The first display unit 130 may include a thin film transistor-liquid crystal display (TFT-LCD) and a driver (not shown) to drive the TFT-LCD.

The first display unit 130 may display the plurality of jobs selected, or to be selected, and may show a user that the plurality of jobs are set to be stapled together. Thus, the image forming apparatus 100 may perform printing with regard to the plural jobs and staple the recording media, on which the plural jobs are printed, according to the stapling options set by the user.

As described above, information about the stapling options set for the plural jobs may be stored in the first storage unit 140. Additionally, the first storage unit 140 may store print data received as plural jobs from outside the image forming apparatus 100, a scan image generated by a scanning unit, user registration, authentication and authority information set according to user accounts, etc.

The first storage unit 140 may include an internal storage medium such as an HDD, or an external or portable storage medium such as a USB memory, a memory card (memory stick, compact flash (CF) card, a multi-media card (MMC)), etc.

The first communication unit 150 may perform data communication with an external apparatus such as the host apparatus 200, a server, etc. The first communication unit 150 may include a wired/wireless communication module connectable with the external apparatus such as the host apparatus 200 locally or through a network based on a predetermined protocol, a universal serial bus (USB) port connectable with a portable storage medium such as a USB memory, etc. Also, the first communication unit 150 may include a fax communication module that converts data read by a scanning unit (not shown) into a fax signal and may transmit the fax signal or receive a fax signal sent from outside the image forming apparatus 100. Further, the first communication unit 150 may perform a scan-to-host or scan-to-server function of transmitting the scan data to the external apparatus such as the host apparatus 200 or the server, or may perform a scan-to-email function or the like to transmit the scan data out from the image forming apparatus 100.

The stapling unit 160 may staple the recording media aligned after an image is printed thereon, as a post-processing function applied to the recording media upon the printing operation being completed. The stapling unit 160 may include an electromotive stapler to apply the stapling to the recording media under control of the first controller 180. Also, as previously discussed, stapling is but one manner of affixing the recording media together, and the present general inventive concept is not limited thereto. In other words, other forms of affixing recording media together, which performs the intended purpose of the inventive concept as described herein, may be used.

The medium discharging unit 170 may include a discharging roller to discharge the recording medium on which an image is printed to the outside of the image forming apparatus 100. The medium discharging unit 170 may include at least one of a stacker, a finisher, a sorter, a puncher, etc., to stack and/or sort the discharged recording media or apply post-processing functions to the sorted recording media (e.g., paper).

The first controller 180 may perform general control for the image forming apparatus 100. In more detail, if a plurality of jobs are selected to be stapled together through the first user selection unit 120, the first controller 180 may control the image forming unit 110 to print the selected plural jobs and the stapling unit 160 to staple the recording media, on which images corresponding to the selected plural jobs are printed, together.

Further, the first controller 180 may control the medium discharging unit 170 to discharge the stapled recording media from the image forming apparatus 100.

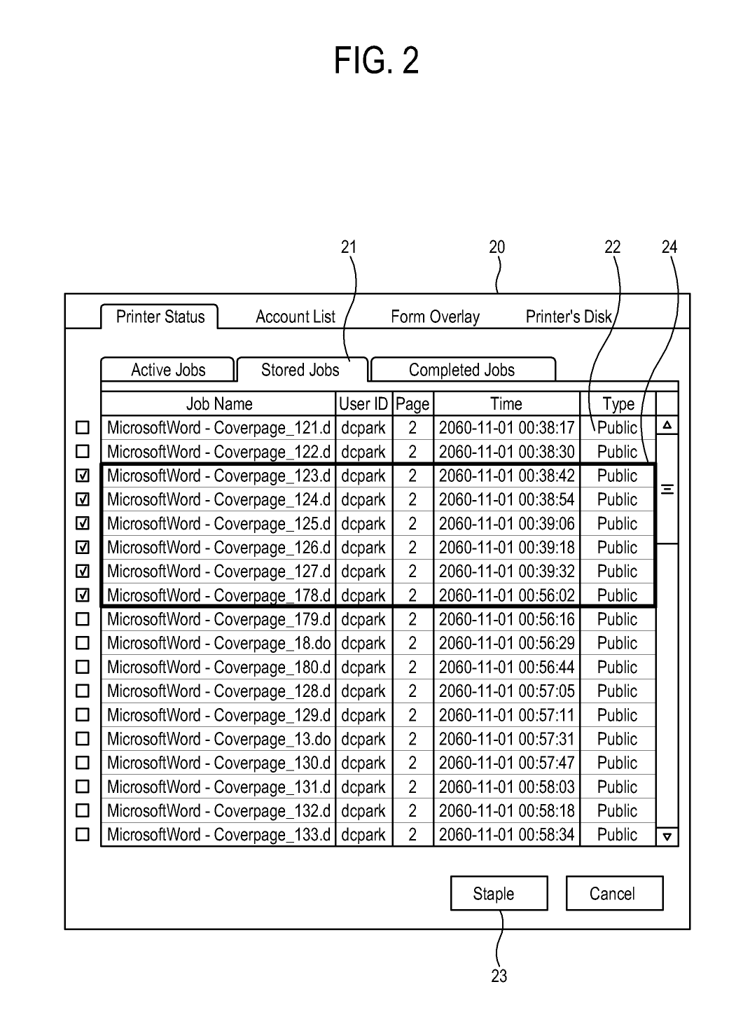

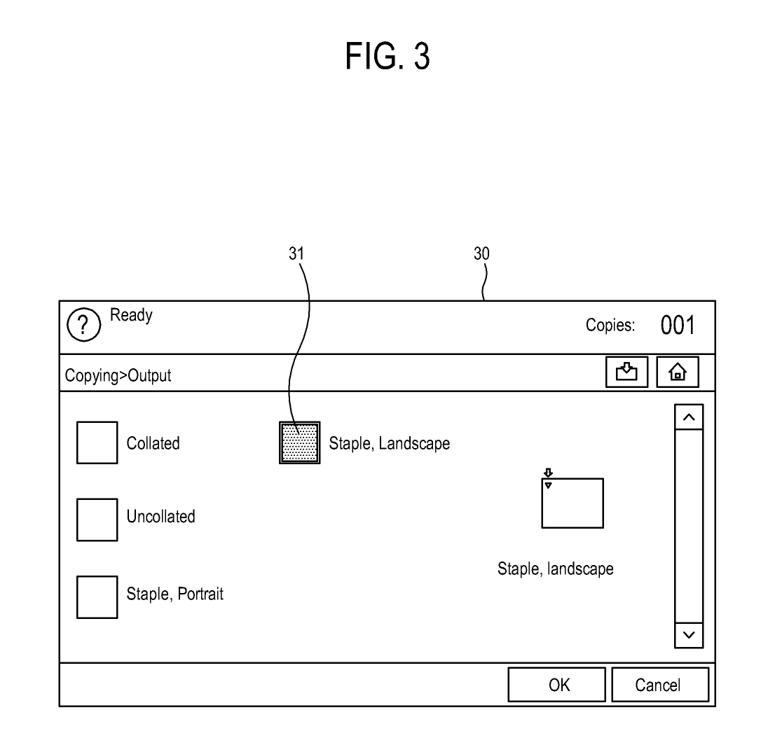

FIG. 2 illustrates a selecting screen 20 used to select a plurality of jobs according to the embodiment illustrated in FIG. 1, and FIG. 3 illustrates a setting screen 30 used to set stapling options.

As illustrated in FIG. 2, the first controller 180 may control the first display unit 130 to display, on the selecting screen 20, the operating statuses of the image forming apparatus 100 according to a user's request. If a user selects a stored-jobs tab 21, the first display unit 130 may display a list 22 of jobs stored in the first storage unit 140.

Then, a user may select a plurality of jobs to be stapled together in the stored-jobs list 22, and may select a staple button 23 (refer to FIG. 2) to indicate that the selected plurality of jobs are to be stapled together. The selected plurality of jobs 24 may be indicated on the first display unit by a checked box, a darkened border, a change in shading, or other such indicators, or a combination thereof.

The first controller 180 may control the first display unit 130 to display the setting screen 30 used to set the stapling options as illustrated in FIG. 3 when a user selects the staple button 23. A user may select the stapling orientation, the stapling position, etc., on the setting screen 30 (refer to FIG. 3). For example, in FIG. 3 the user has selected the “Staple, Landscape” option 31 from the displayed stapling options. The setting screen 30 illustrated in FIG. 3 merely illustrates a few example stapling options, and it is understood that the present general inventive concept is not limited thereto.

The first controller 180 may control the image forming unit 110 to sequentially print the plurality of jobs selected in FIG. 2. If the printing of all the selected plural jobs is completed, the first controller 180 may control the stapling unit 160 to staple the recording media corresponding to the selected plural jobs together in response to the set stapling options. Here, the first controller 180 may align the recording medium on which the printing has been performed, and may apply the stapling to the aligned recording medium through the stapling unit 160.

Further, the first controller 180 may control the medium discharging unit 170 to discharge the recording media corresponding to the selected plurality of jobs which have been stapled together.

If the total number of sheets of the recording media corresponding to the selected plurality of jobs reaches a stapling limit of the image forming apparatus 100 in this embodiment, the first controller 180 may control a GUI to be displayed which allows a user to select whether to perform the stapling divisionally and may control the stapling unit 160 to divide the stapling of the sheets of media on which the selected jobs are printed two or more times according to the selection results.

Meanwhile, the present general inventive concept may use the host apparatus 200, instead of or in combination with the image forming apparatus 100, in various operations included in the stapling of the plurality of jobs together.

FIG. 4 is a block diagram illustrating the host apparatus 200 according to another exemplary embodiment of the present general inventive concept. The host apparatus 200 in this embodiment, which may be achieved by a personal computer (PC) or the like, may transmit print data, a printing command, etc., to the image forming apparatus 100 and may receive various status information of the image forming apparatus 100.

A user may log in to the host apparatus 200 and access the image forming apparatus 100, so that the print data and the printing command including the stapling options can be transmitted to the image forming apparatus 100.

As illustrated in FIG. 4, the host apparatus 200 may include an image processing unit 210, a second user selection unit 220, a second display unit 230, a second storage unit 240, a second communication unit 250, and a second controller 280.

The image processing unit 210 may generate print data by performing an image process using a predetermined print language such as a post script (PS), a printer control language (PCL), etc., to a job-object document in response to a printing command. Specifically, the image processing unit 210 may call a printer driver or an application linkable with a printer driver in response to receiving a user's printing command, and may apply operations such as rendering and half-toning to a document to be printed, thereby generating print data and spooling the generated print data. The spooled print data may be transmitted to the image forming apparatus 100 through the second communication unit 250.

The second user selection unit 220 may receive a user's command. The second user selection unit 220 may include a key button (hereinafter, referred to as “hard key” or a “key pad”) such as that provided at the image forming apparatus 100, or a graphic user interface (GUI) produced by execution of a printer driver or a separate application and displayed on the second display unit 230 to thereby allow a user to input a command through the GUI.

Through the second user selection unit 220, a user may select plural jobs to be stapled together among a plurality of jobs, and may set stapling options with regard to the selected plural jobs. The options may include a stapling orientation, a stapling position, etc. Further, the second user selection unit 220 may allow a user to set printing properties with respect to the selected plural jobs.

Also, a user may perform a log-in, i.e., inputting an input identification (ID) code assigned to his/her account and password through the second user selection unit 220. The log-in may include an administrator mode log-in, after which an administrator is allowed to set and modify all environments without any separate limitation on access. If the log-in is performed as a general user or an administrator, the host apparatus 200 may transmit information about the log-in to the image forming apparatus 100, and the image forming apparatus 100 may implement authentication and permission with regard to the log-in.

The second display unit 230 may show a user the setting and operating statuses of the image forming apparatus 100, received through the second communication unit 250, and may display a GUI screen through which a user may input various commands.

The second display unit 230 may include a thin film transistor-liquid crystal display (TFT-LCD) and a driver (not shown) to drive the TFT-LCD.

The second user selection unit 220 of the host apparatus 200 in this embodiment may be a remote user interface (RUI) or a web user interface (WUI) of the image forming apparatus 100, which accesses the image forming apparatus 100 through the second communication unit 250 and allows a user to set the image forming apparatus 100 according to various available settings.

If the second user selection unit 220 is the RUI of the image forming apparatus 100, the second display unit 230 may display to a user a setting screen in the image forming apparatus 100 in order to select and/or staple the plurality of jobs.

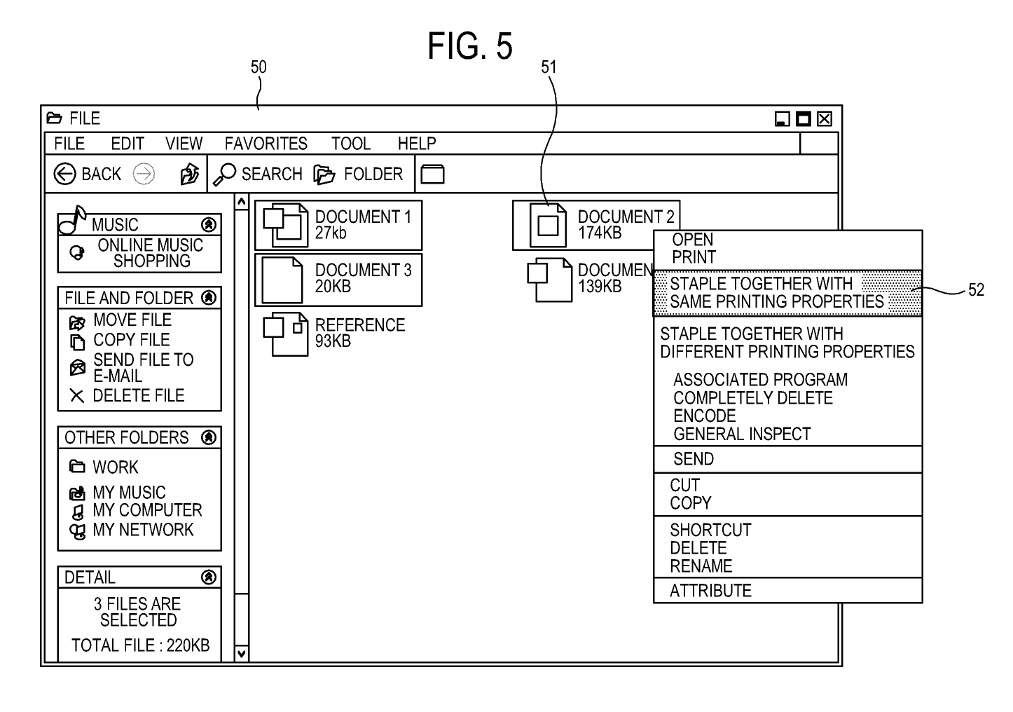

In more detail, the second display unit 230 may display to the user the plurality of stored jobs which may be selected to be stapled together. The information displayed by the second display unit 230 may be similar to that illustrated in FIG. 2, which illustrates one embodiment of a display of the first display unit 130. That is, the selecting screen 20 of FIG. 2 may be provided to a user through the host apparatus 200 in the form of a web browser or the like, or a different selecting screen (such as illustrated in FIG. 5, which will be discussed later in this description) displaying the stored job information may be provided to the user.

Thus, the image forming apparatus 100 may perform the printing with respect to the plurality of jobs in response to the command received from the host apparatus 200, and may perform the stapling according to the stapling options with respect to the recording media corresponding to the selected plural jobs, upon completion of the printing of same, according to the stapling options set by a user.

As described above, information regarding the stapling options set for the selected plural jobs may be transmitted to the image forming apparatus 100 through the second communication unit 250.

The second communication unit 250 may perform data communication with an external apparatus including the image forming apparatus 100. The second communication unit 250 may include a wired/wireless communication module connectable with the external apparatus locally or through a network based on a predetermined protocol, a universal serial bus (USB) port connectable with a portable storage medium such as a USB memory, etc.

The second storage unit 240 may store a job object file, a driver used in communication with the image forming apparatus 100, information about an application, etc. The second storage unit 240 may include an internal storage medium such as an HDD, an external or portable storage medium such as a USB memory, a memory card (memory stick, compact flash (CF) card, a multi-media card (MMC)), etc.

The second controller 280 may perform general control for the host apparatus 100. In more detail, if a plurality of jobs is selected to be stapled together through the second user selection unit 220, the second controller 280 may control the image processing unit 210 to generate the print data with respect to the selected plural jobs, and the second communication unit 250 to send the image forming apparatus 100 the print data and a command of stapling together the recording media on which images corresponding to the selected plural jobs are printed.

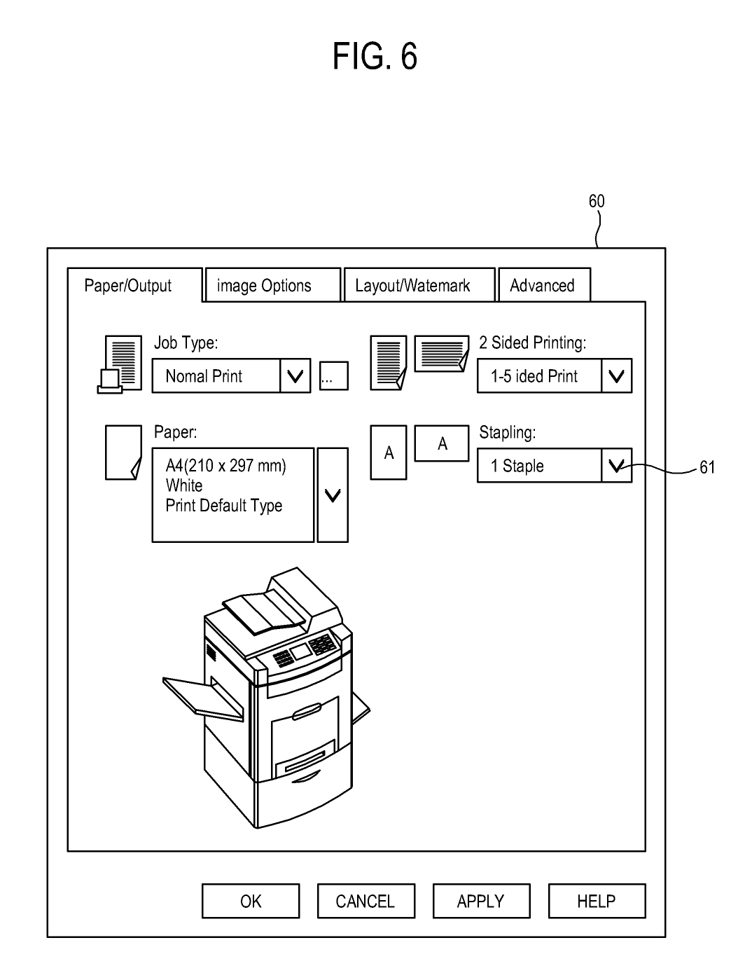

FIG. 5 illustrates a selecting screen 50 used to select a plurality of jobs according to the exemplary embodiment illustrated in FIG. 4, and FIG. 6 illustrates a setting screen 60 used to set stapling options according to the exemplary embodiment illustrated in FIG. 4.

As illustrated in FIG. 5, if a user inputs a prompt indicating a desire to print a plurality of job objects through an interface such as a GUI, the second controller 280 may control the second display unit 230 to display the selecting screen 50 to be used to select a plurality of files as the plurality of job objects.

If a user inputs a corresponding prompt, such as clicking a right button of a mouse while selecting a plurality of files, the second controller 280 may control the second display unit 230 to display a context menu 52 as illustrated in FIG. 5 to be used by the user to choose processing options for the selected files 51.

In the host apparatus 200 of this embodiment, the displayed context menu may include options such as “STAPLE TOGETHER WITH SAME PRINTING PROPERTIES,” STAPLE TOGETHER WITH DIFFERENT PRINTING PROPERTIES,” etc.

Here, the selectable option of “STAPLE TOGETHER WITH SAME PRINTING PROPERTIES” indicates that the printing properties such as paper size, paper orientation, layout, a double/single-sided print, a reverse-ordered print, etc., are equally set with respect to all the selected plural jobs, while printing the corresponding jobs, and then the corresponding plural jobs are stapled together.

On the other hand, the selectable option of “STAPLE TOGETHER WITH DIFFERENT PRINTING PROPERTIES” indicates that the printing properties such as paper size, paper orientation, layout, a double/single-sided print, a reverse-ordered print, etc., may be set individually with respect to the selected plural jobs, and then the corresponding plural jobs are stapled together. Accordingly, this embodiment of the present general inventive concept makes it possible to staple the recording media corresponding to the plurality of jobs together while maintaining the respective printing properties of each job.

If a user selects the plurality of jobs to be stapled together in the context menu 52 illustrated in FIG. 5, the second controller 280 may control the second display unit 230 to display the setting screen 60 to display the stapling options as illustrated in FIG. 6. Through the setting screen 60, a user may select such options as the stapling orientation, the stapling position, etc.

If a user has selected the option of “STAPLE TOGETHER WITH DIFFERENT PRINTING PROPERTIES”, the second display unit 230 may display the stapling-option setting screen 60 of FIG. 6 with respect to each of the selected plural jobs. In more detail, a user may select a drop-down list 61 to set the stapling option in the stapling-option setting screen 60 of FIG. 6, and may select at least one of the start, continue and end jobs of the stapling.

If the stapling options are set through the second user selection unit 220, the second controller 280 may control the second communication unit 250 to transmit start information regarding the stapling together operation in addition to the print data of the first job among the plural jobs selected in FIG. 5, and to transmit end information regarding the stapling together operation in addition to the print data of the last job. Likewise, continue information may be transmitted in addition to the print data to which continue properties regarding the stapling together operation are given.

The image forming apparatus 100 may form images based on the respective print data corresponding to the plural jobs received from the host apparatus 200, and may print the images. If the print data contains one of the start, continue and end jobs of the of the stapling together operation, the image forming apparatus 100 may staple the recording media corresponding to the plurality of jobs together after the plurality of jobs corresponding to the print data are all completely printed, and may then discharge them.

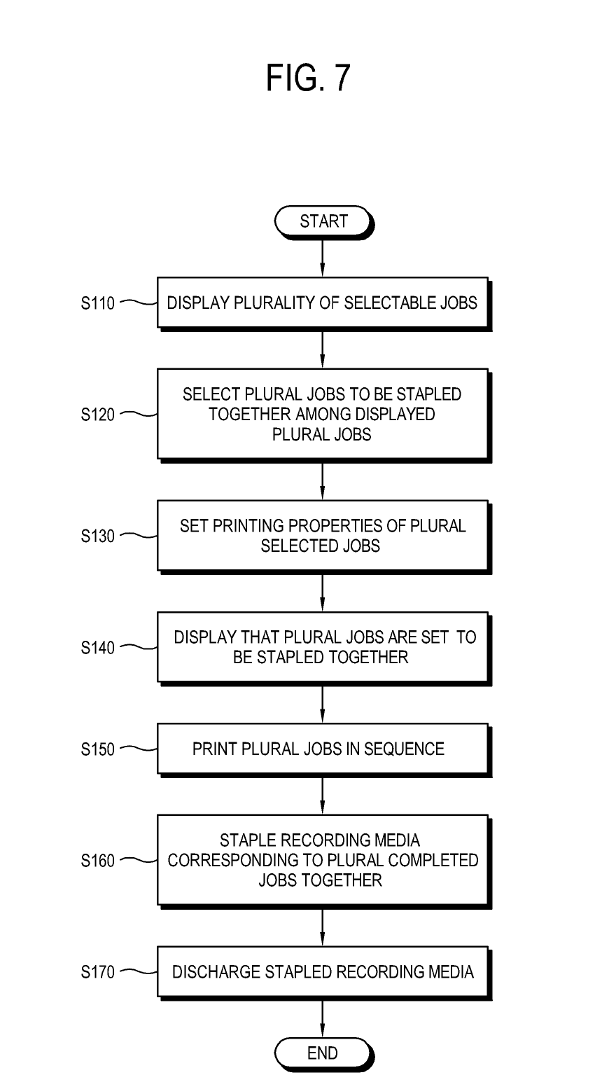

FIG. 7 is a flowchart of a stapling control method according to an exemplary embodiment of the present general inventive concept. The method will be discussed in regard to the image forming apparatus 100 and host apparatus 200 previously described, but it is understood that the method may be practiced without these particular apparatuses.

As illustrated in FIG. 7, at operation S110, the image forming apparatus 100 or the host apparatus 200 may display a plurality of selectable jobs. Here, the image forming apparatus 100 may display the jobs stored in the first storage unit 140 as the selectable jobs, as illustrated in FIG. 2.

Also, the host apparatus 200 may receive status information from the image forming apparatus 100, and may display to a user the jobs stored in the first storage unit 140 of the image forming apparatus 100 through the web browser as illustrated in FIG. 2, or a plurality of files stored in the second storage unit 240 through a GUI as shown in FIG. 5.

At operation S120, the user may select a plurality of jobs to be stapled together among the plurality of jobs displayed in the operation S110.

More particularly, in the image forming apparatus 100 or the host apparatus 200, a user may select the staple button 23 upon selecting the plurality of jobs to be stapled together among the stored jobs displayed in FIG. 2, or may select the “STAPLE TOGETHER WITH SAME PRINTING PROPERTIES” or “STAPLE TOGETHER WITH DIFFERENT PRINTING PROPERTIES” using the context menu 51 upon selecting the plurality of jobs to be stapled together as shown in FIG. 5.

Here, a user may set a printing order with respect to the plurality of selected jobs, so that the plurality of jobs can be printed in the set printing order and stapled together.

Although the described embodiments have involved the printing properties being set through the context menu 51 and setting screen 60 associated with the host apparatus 200 of FIG. 4, the present general inventive concept is not limited thereto. Similar context menus and setting screens may also be displayed at the image forming apparatus 100 itself to allow a user to select and set such options as the discussed individual printing properties of the respective print jobs and the stapling characteristics of stapling the selected print jobs together.

At operation S130, the user may set the printing properties with regard to the plurality of jobs selected in the operation S120. Here, a user may individually set the selected plural jobs to have different printing properties.

In operation S130, a user may further set the stapling options. The screen used to set the stapling options may be the same as illustrated in FIG. 4 or 6. The stapling options may include the stapling orientation, the stapling position, etc.

At operation S140, the image forming apparatus 100 or the host apparatus 200 may show that the plurality of jobs are set to be stapled together in response to the settings in the operation S120.

At operation S150, the image forming apparatus 100 may sequentially print the plural jobs selected in the operation S120. If the operations S120 and S130 are performed in the host apparatus 200 or other remote device, the operation S150 may include transmitting the print data corresponding to the selections and settings made in operations S120 and S130 from the host apparatus 200 to the image forming apparatus 100.

At operation S160, the image forming apparatus 100 may staple together the recording media on which the printing is completed in operation S150 with respect to the selected plurality of jobs. If the total number of sheets of the recording media corresponding to the plurality of jobs reaches a stapling limit of the image forming apparatus 100 in this embodiment, a GUI may be displayed to allow the user to select whether to perform the stapling divisionally, and the stapling may be performed by dividing the total number of the media sheets two or more times according to the selection results.

If the stapling of the operation S160 is completed, at operation S170 the image forming apparatus 100 may discharge the stapled recording media.

As described above, the image forming apparatus 100 according to an exemplary embodiment of the present general inventive concept may affix a plurality of jobs together, such as by stapling the plurality of jobs together, while maintaining the individual printing properties of each job, thereby providing a more efficient stapling operation and providing more options a user.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various exemplary embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A stapling control method of an image forming apparatus that performs printing with respect to a plurality of jobs, the method comprising:
displaying a plurality of selectable jobs;
selecting a plurality of the selectable jobs to be stapled together; and
stapling the selected jobs together while maintaining printing properties of each of the respective selected jobs.

2. The method according to claim 1, further comprising:
setting the printing properties with respect to the selected jobs.

3. The method according to claim 2, wherein the setting of the printing properties comprises:
setting the printing properties of the selected jobs to be equal.

4. The method according to claim 1, further comprising:
discharging recording media that are stapled together.

5. The method according to claim 1, wherein the displaying of the plurality of selectable jobs comprises:
displaying a list of plural selectable jobs stored in the image forming apparatus.

6. The method according to claim 1, wherein the selecting of the plurality of the selectable jobs comprises:
selecting a plurality of files corresponding to the plurality of selectable jobs through a graphical user interface (GUI) in a host apparatus connectable with the image forming apparatus.

7. The method according to claim 1, further comprising:
displaying that the selected jobs are set to be stapled together.

8. An image forming apparatus comprising:
an image forming unit to print a plurality of jobs;
a display unit to display a plurality of selectable jobs;
a user selection unit to allow a user to select a plurality of the selectable jobs to be stapled together;
a stapling unit to staple recording media on which printing is completed; and
a controller to control the stapling unit to staple the recording media corresponding to the selected jobs together while maintaining printing properties of each of the respective selected jobs.

9. The image forming apparatus according to claim 8, wherein the user selection unit allows the user to set printing properties with respect to the selected jobs.

10. The image forming apparatus according to claim 9, wherein the user selection unit allows the user to set the printing properties of the selected jobs to be equal.

11. The image forming apparatus according to claim 8, further comprising:
a medium discharging unit to discharge recording media that are stapled together.

12. The image forming apparatus according to claim 8, further comprising:
a storage unit in which a plurality of jobs are stored;
wherein the display unit displays a list of plural selectable jobs stored in the storage unit.

13. The image forming apparatus according to claim 8, wherein the display unit displays that the selected jobs are set to be stapled together.

14. A host apparatus connectable with an image forming apparatus, the host apparatus comprising:
a communication unit to communicate with the image forming apparatus;
a display unit to display a plurality of selectable jobs;
a user selection unit to allow a user to select a plurality of the selectable jobs to be stapled together; and
a controller to control the communication unit to transmit a command to staple the selected jobs together while maintaining printing properties of each of the respective selected jobs.

15. The host apparatus according to claim 14, wherein the user selection unit allows the user to set printing properties with respect to the selected jobs.

16. The host apparatus according to claim 15, wherein the user selection unit allows the user to set the printing properties of the selected jobs to be equal.

17. The host apparatus according to claim 14, wherein the user selection unit allows the user to select a plurality of files corresponding to the plurality of selectable jobs through a graphical user interface (GUI).

18. The host apparatus according to claim 14, wherein the display unit displays that the selected jobs are set to be stapled together.

19. A method of affixing a plurality of printed jobs together, the method comprising:
selecting a plurality of jobs to be affixed together; and
affixing the selected jobs together upon printing of the selected jobs;
wherein respective printing properties of the selected jobs are maintained during the printing.

20. The method of claim 19, wherein the affixing of the selected jobs together comprises stapling.

21. The method of claim 19, further comprising:
displaying a plurality of selectable jobs.

22. The method of claim 19, wherein the printing properties include paper size, paper orientation, layout, double/single-sided printing, reverse-ordered printing, or any combination thereof.

23. An image forming apparatus comprising:
an affixing device to affix sheets of recording media together; and
a control circuit to control the affixing device to affix a plurality of print jobs together upon printing of the print jobs;
wherein respective printing properties of the print jobs are maintained during the printing.

24. The image forming apparatus of claim 23, further comprising:
a display to display a plurality of selectable jobs that may be printed.

25. The image forming apparatus of claim 23, further comprising:
a communication unit to receive print data regarding the print jobs to be affixed together,
wherein the print data includes a selection of the print jobs to be affixed together, affixing properties, the respective printing properties, or any combination thereof.
